(19) United States
(12) Patent Application Publication
(10) Pub. No.: US 2020/0409025 A1
(43) Pub. Date: Dec. 31, 2020

(54) LENS MODULE

(71) Applicant: AAC Optics Solutions Pte. Ltd., Singapore city (SG)

(72) Inventor: Chuandong Wei, Shenzhen (CN)

(21) Appl. No.: 16/914,484

(22) Filed: Jun. 29, 2020

(30) Foreign Application Priority Data
Jun. 29, 2019 (CN) PCT/CN2019/094026

(51) Int. Cl. G02B 7/02; G02B 13/00

(52) U.S. Cl. CPC G02B 7/026; G02B 13/0045; G02B 7/021

(57) ABSTRACT

A lens module is provided, including a lens barrel with an accommodation space, a lens group, and a press ring. The lens barrel includes a first barrel wall and a second barrel wall, which surround to form the accommodation space. The lens group is sandwiched between the first barrel wall and the press ring. The press ring includes a top and bottom surface respectively adjacent to an object and image side, an outer side surface connecting the top surface and the bottom surface and adjacent to the second barrel wall, and an annular groove formed by recessing from the top surface to the bottom surface. The annular groove is located at one end of the top surface that is adjacent to the outer side surface and configured to avoid burrs of the lens group. Compared with related technology, the lens module provided in the present disclosure has higher reliability.

### TECHNICAL FIELD

The present disclosure relates to the field of optical imaging, in particularly to a lens module.

### BACKGROUND

In recent years, with the continuous development of science and technology, electronic devices are continuously developing towards intelligence. In addition to digital cameras, portable electronic devices such as tablet computers and mobile phones are also equipped with lens modules having photo shooting and video shooting functions, as well as vehicles such as cars are equipped with the lens modules having the photo shooting and video shooting functions, so as to meet the needs of users to take photos at any time.

The lens module in the related technology includes a lens barrel, a lens group accommodated in the lens barrel and a press ring that holds the lens group in the lens barrel, and the press ring is abutted with the lens group and is fixed on the lens barrel by means of dispensing.

However, since an outer surface of the lens of the lens group may generate burrs during the manufacturing process, and the press ring is not configured with a clearance structure for avoiding the burrs of the lens, so that the surface where the press ring abuts against the lens group is uneven, thus affecting the stability of the connection between the press ring and the lens barrel.

Therefore, it is necessary to provide an improved lens module to solve the above problems.

### SUMMARY

With respect to the technical problem that a connection between a press ring and a lens barrel in the lens module is unstable in the related technology, the present disclosure provides a lens module with good reliability.

A lens module includes a lens barrel with an accommodation space, a lens group accommodated in the accommodation space, and a press ring that holds the lens group in the accommodation space. The lens barrel includes a first barrel wall configured with a light through hole, and a second barrel wall bending and extending from the first barrel wall. The first barrel wall and the second barrel wall surround to form the accommodation space. The lens group is sandwiched between the first barrel wall and the press ring. The press ring includes a top surface adjacent to an object side, a bottom surface adjacent to an image side, an outer side surface connecting the top surface and the bottom surface and adjacent to the second barrel wall, and an annular groove formed by recessing from the top surface to the bottom surface. The annular groove is located at one end of the top surface that is adjacent to the outer side surface, and the annular groove is configured to avoid a burr of the lens group.

Preferably, the lens group includes a first lens adjacent to the image side, the first lens includes a side-wall surface adjacent to the second barrel wall and an image side surface adjacent to the image side and connected with the side-wall surface, and an orthographic projection of a connection between the image side surface and the side-wall surface along a direction of an optical axis falls into the annular groove.

Preferably, the top surface includes a first horizontal plane horizontally extending from an inner edge of the annular groove in the direction adjacent to the optical axis and a second horizontal plane horizontally extending from an outer edge of the annular groove in the direction away from the optical axis and connected with the outer side surface, the annular groove connects the first horizontal plane and the second horizontal plane, the first horizontal plane is abutted against the image side surface of the first lens, and the second horizontal plane and the annular groove are arranged at intervals with the image side surface.

Preferably, a cross section of the annular groove is semicircular.

Preferably, a cross section of the annular groove is square.

Preferably, the annular groove includes an arc surface connected with the first horizontal plane, a first side surface connected with the second horizontal plane and perpendicular to the second horizontal plane, and a groove bottom connecting the arc surface and the first side surface.

Preferably, the arc surface protrudes outwardly in the direction adjacent to the second barrel wall.

Compared with the related technology, the lens module in the present disclosure is configured with the annular groove on the surface where the press ring is abutted against the lens group, and the annular groove is configured to avoid the burrs of the lens group, which enhances the matching stability of the press ring and the lens group, thereby stabilizing the connection between the press ring and the lens barrel and improving the reliability of the lens module.

### BRIEF DESCRIPTION OF THE DRAWINGS

In order to illustrate the technical solution in the embodiments of the present disclosure more clearly, the accompanying drawings used in the description of the embodiments are briefly introduced below. It is apparent that the drawings descripted below are only some embodiments of the present disclosure. For those skilled in the art, other drawings may be obtained in accordance with these drawings without any creative work, where:

FIG. 1 is a cross-sectional view of a lens module provided in Embodiment 1 of the present disclosure;

FIG. 2 is a partially enlarged view of a region A shown in FIG. 1;

FIG. 3 is a schematic cross-sectional view of a structure of a press ring shown in FIG. 1;

FIG. 4 is a cross-sectional view of the lens module provided in Embodiment 2 of the present disclosure;

FIG. 5 is a partially enlarged view of a region B shown in FIG. 4;

FIG. 6 is a schematic cross-sectional view of a structure of the press ring shown in FIG. 4;

FIG. 7 is a cross-sectional view of the lens module provided in Embodiment 3 of the present disclosure;

FIG. 8 is a partially enlarged view of a region C shown in FIG. 7; and

FIG. 9 is a schematic cross-sectional view of a structure of the press ring shown in FIG. 7.

### DETAILED DESCRIPTION

The technical solutions in the embodiments of the present disclosure will be clearly and completely described with reference to the accompanying drawings in the present disclosure. It is evident that the embodiments described are only some rather than all embodiments in the present disclosure. Based on the embodiments of the present disclosure, all other embodiments obtained by those of ordinary skills in the art without any creative work shall fall within the protection scope of the present disclosure.

### Embodiment 1

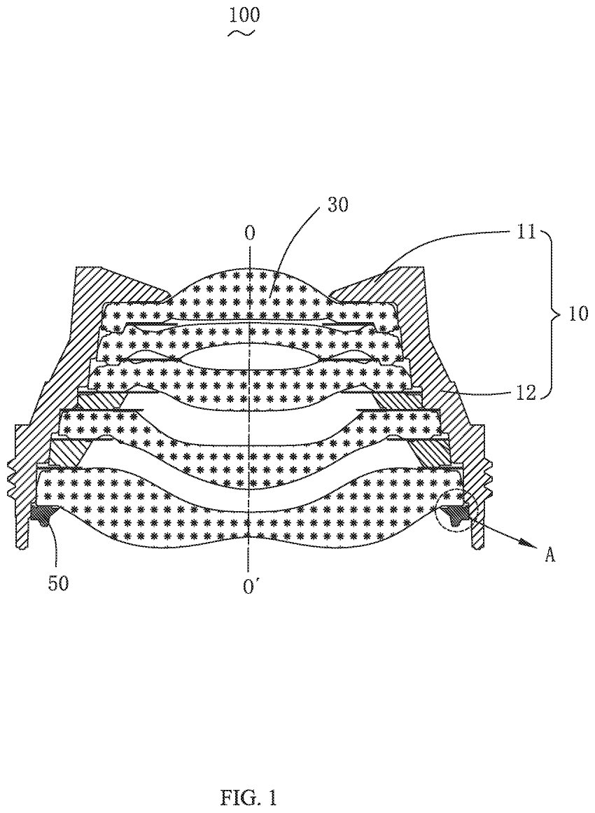

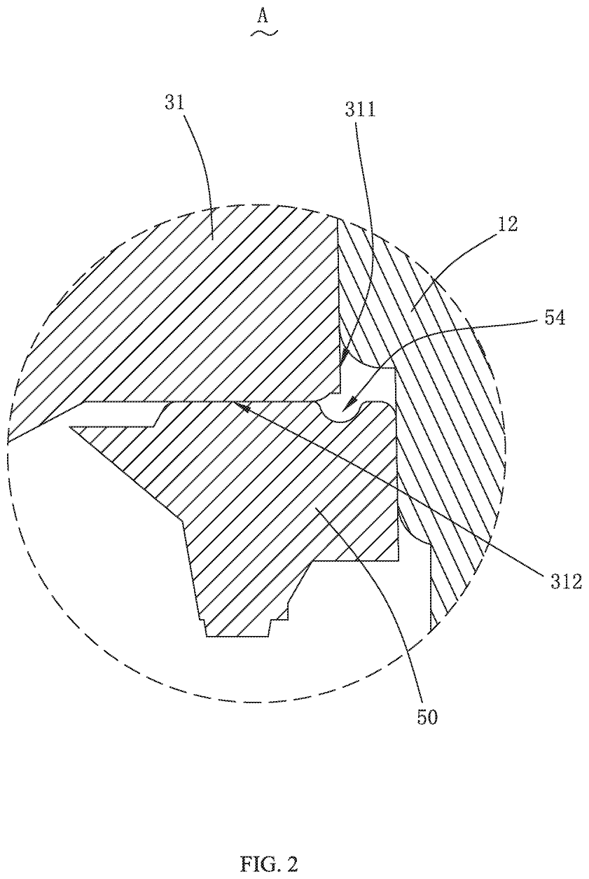

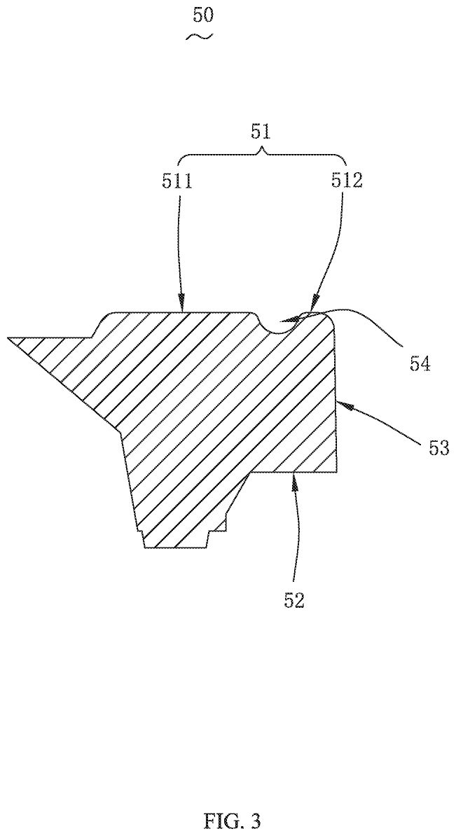

Referring to FIG. 1 to FIG. 3. This embodiment provides a lens module 100, which includes a lens barrel 10, a lens group 30 accommodated in the lens barrel 10, and a press ring 50 that holds the lens group 30 in the lens barrel 10.

The lens barrel 10 includes a first barrel wall 11 configured with a light through hole and a second barrel wall 12 bending and extending from the first barrel wall 11. The first barrel wall 11 and the second barrel wall 12 jointly surround to form an accommodation space, and the accommodation space is configured to accommodate the lens group 30. The lens group 30 is sandwiched between the first barrel wall 11 and the press ring 50.

The lens group 30 is composed of a plurality of lenses. In this embodiment, the lens group 30 is composed of five lenses. Specifically, the lens group 30 includes a first lens 31, and the first lens 31 is a lens adjacent to an image side. The first lens 31 includes a side-wall surface 311 adjacent to the second barrel wall 12 and an image side surface 312 adjacent to the image side and connected to the side-wall surface 311.

The press ring includes a top surface 51 adjacent to an object side, a bottom surface 52 adjacent to the image side, an outer side surface 53 connecting the top surface 51 with the bottom surface 52 and adjacent to the second barrel wall 12, and an annular groove 54 formed by recessing from the top surface 51 to the bottom surface 52. The annular groove 54 is located at one end of the top surface 51 that is adjacent to the outer side surface 53, and the annular groove 54 is configured to avoid burrs of the first lens 31.

The top surface 51 abuts against the image side surface 312 of the first lens 31, so that the press ring 50 presses the first lens 31 into the lens barrel 10. Since the first lens 31 is easy to generate burrs in the manufacturing process, especially the position where the image side surface 312 of the first lens 31 is connected with the side-wall surface 311, the annular groove 54 is configured on the top surface 51 of the press ring 50 to avoid the burrs of the first lens 31 and enhance the matching stability of the press ring 50 and the first lens 31, thereby improving the reliability of the lens module 100. Preferably, an orthographic projection of a connection between the image side surface 312 and the side-wall surface 311 along a direction of an optical axis OO′ falls into the annular groove 54. Since the connection between the image side surface 312 and the side-wall surface 311 is the portion that is most likely to generate the burrs, with the above structure, a better avoidance effect can be achieved.

Specifically, the top surface 51 includes a first horizontal plane 511 horizontally extending from an inner edge of the annular groove 54 in the direction adjacent to the optical axis OO′ and a second horizontal plane 512 horizontally extending from an outer edge of the annular groove 54 in the direction away from the optical axis OO′ and connected with the outer side surface 53. The annular groove 54 connects the first horizontal plane 511 and the second horizontal plane 512. The first horizontal plane 511 is abutted against the image side surface 312 of the first lens 31. The second horizontal plane 512 and the annular groove 54 are arranged at intervals with the image side surface 312. The second horizontal surface 512, the annular groove 54 and the image side surface 312 jointly surround to form a space for avoiding the burrs. Such a structure design can maximize the use of the space and has a good effect of avoiding the burrs.

In this embodiment, a cross section of the annular groove 54 is semicircular.

### Embodiment 2

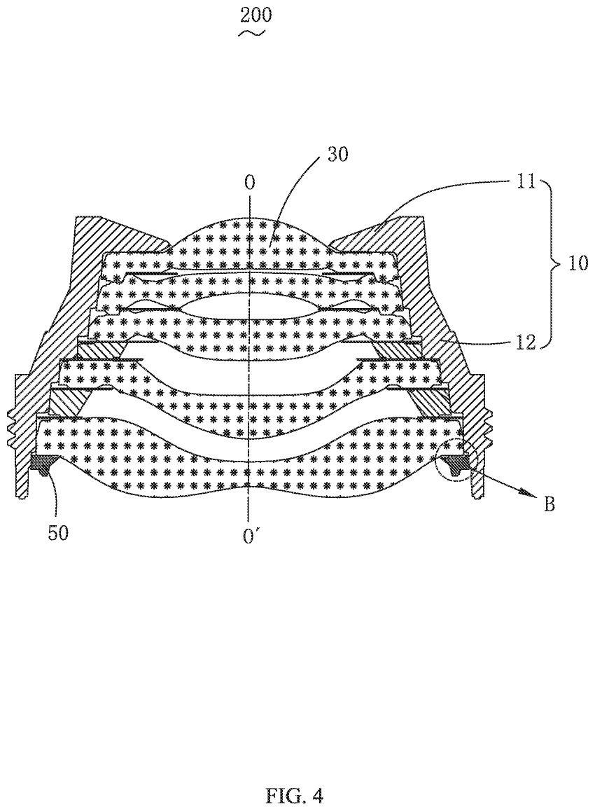

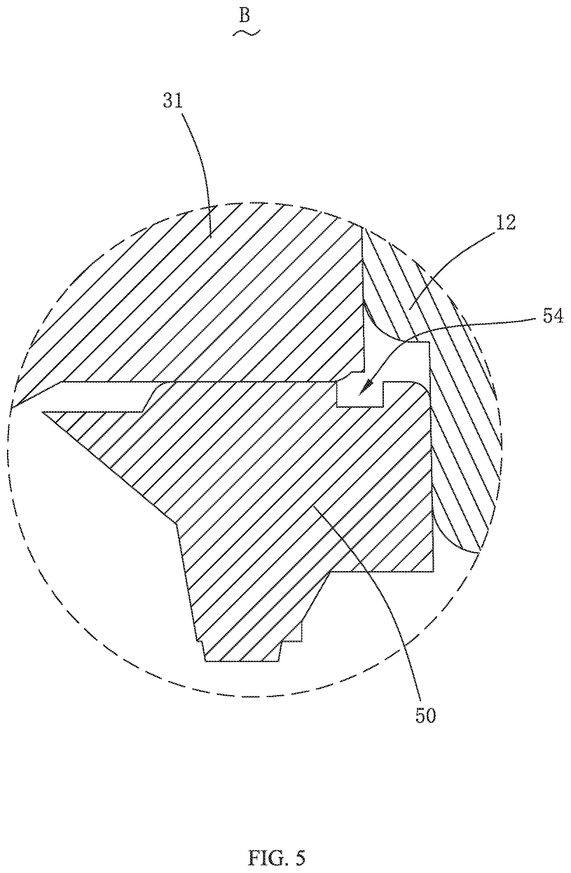

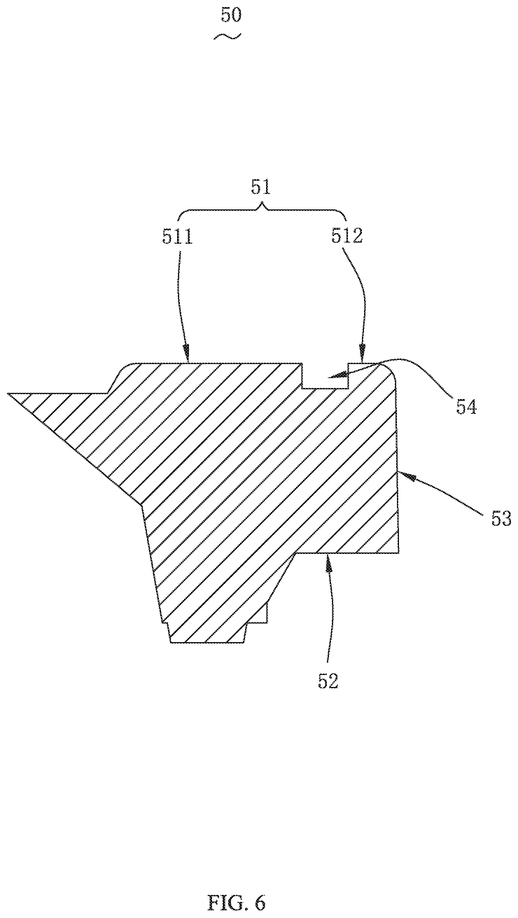

Referring to FIG. 4 to FIG. 6 which are schematic views showing a second embodiment of a lens module provided in the present disclosure. A structure according to Embodiment 2 is integrally the same as the structure according to Embodiment 1. The only difference is that a cross section of an annular groove 54 is square.

### Embodiment 3

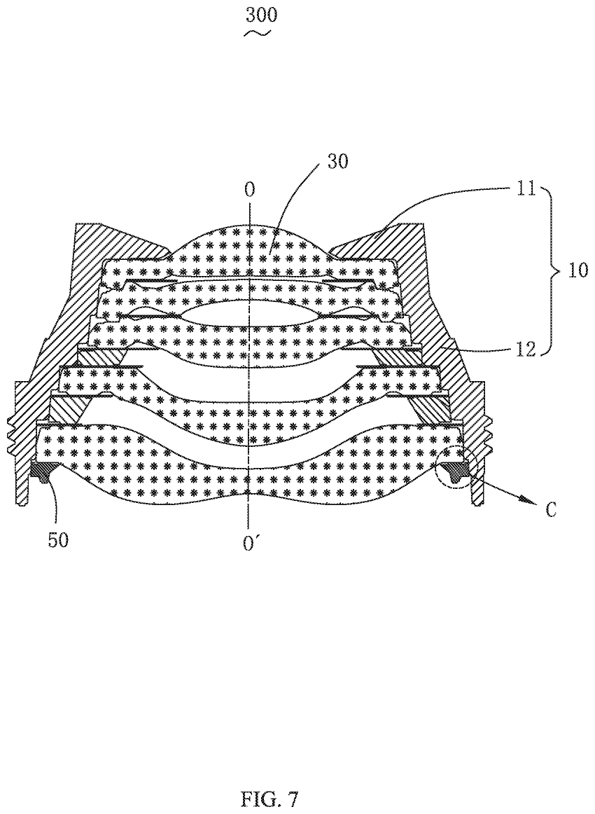

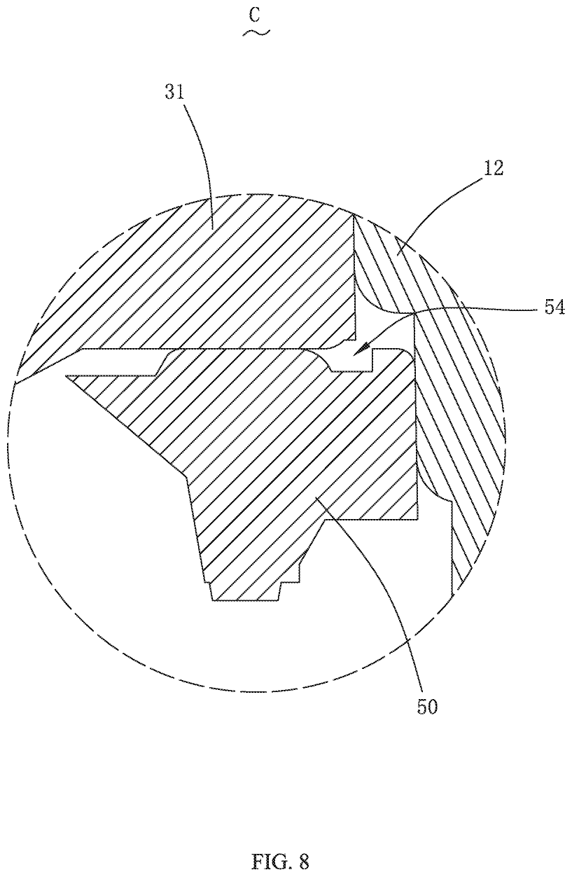

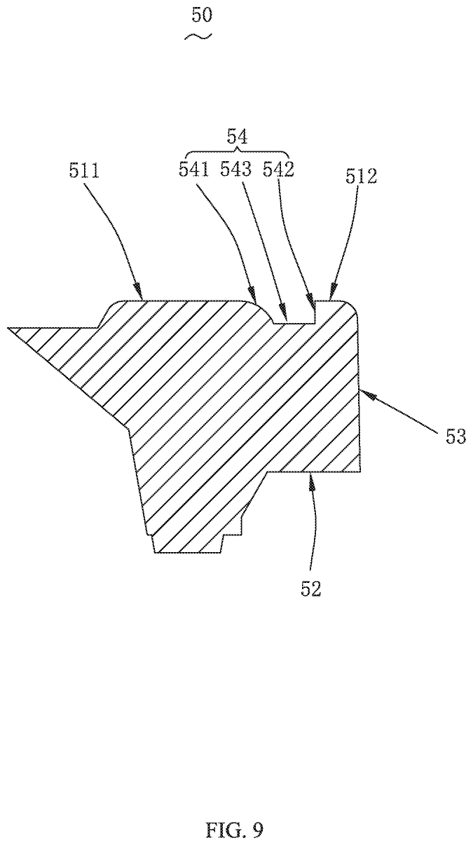

Referring to FIG. 7 to FIG. 9 which are schematic views showing a third embodiment of a lens module provided in the present disclosure. A structure according to Embodiment 3 is integrally the same as the structure according to Embodiment 1. The only difference is that a cross section of an annular groove 54 is composed of arc and square. Specifically, the annular groove 54 includes an arc surface 541 connected with a first horizontal plane 511, a first side surface 542 connected with a second horizontal plane 512 and perpendicular to the second horizontal plane 512, and a groove bottom 543 connecting the arc surface 541 and the first side surface 542. Preferably, the arc surface 541 protrudes outwardly in the direction adjacent to a second barrel wall 12, which further optimizes the avoidance effect.

Compared with the related technology, the lens module in the present disclosure is configured with the annular groove on the surface where the press ring is abutted against the lens group, and the annular groove is configured to avoid the burrs of the lens group, which enhances the matching stability of the press ring and the lens group, thereby stabilizing the connection between the press ring and the lens barrel and improving the reliability of the lens module.

The above description is merely embodiments of the present disclosure, and it should be pointed out that, those of ordinary skills in the art can make improvements without departing from the inventive concept of the present disclosure, but these improvements all belong to the protection scope of the present disclosure.

What is claimed is:

1. A lens module, comprising a lens barrel with an accommodation space, a lens group accommodated in the accommodation space, and a press ring that holds the lens group in the accommodation space; the lens barrel comprising a first barrel wall configured with a light through hole and a second barrel wall bending and extending from the first barrel wall; the first barrel wall and the second barrel wall surrounding to form the accommodation space; the lens group being sandwiched between the first barrel wall and the press ring; the press ring comprising a top surface adjacent to an object side, a bottom surface adjacent to an image side, an outer side surface connecting the top surface and the bottom surface and adjacent to the second barrel wall, and an annular groove formed by recessing from the top surface to the bottom surface; the annular groove being located at one end of the top surface that is adjacent to the outer side surface, and the annular groove being configured to avoid a burr of the lens group.

2. The lens module according to claim 1, wherein the lens group comprises a first lens adjacent to the image side, the first lens comprises a side-wall surface adjacent to the second barrel wall and an image side surface adjacent to the image side and connected with the side-wall surface, and an orthographic projection of a connection between the image side surface and the side-wall surface along a direction of an optical axis falls into the annular groove.

3. The lens module according to claim 2, wherein the top surface comprises a first horizontal plane horizontally extending from an inner edge of the annular groove in the direction adjacent to the optical axis and a second horizontal plane horizontally extending from an outer edge of the annular groove in the direction away from the optical axis and connected with the outer side surface, the annular groove connects the first horizontal plane and the second horizontal plane, the first horizontal plane is abutted against the image side surface of the first lens, and the second horizontal plane and the annular groove are arranged at intervals with the image side surface.

4. The lens module according to claim 1, wherein a cross section of the annular groove is semicircular.

5. The lens module according to claim 1, wherein a cross section of the annular groove is square.

6. The lens module according to claim 3, wherein the annular groove comprises an arc surface connected with the first horizontal plane, a first side surface connected with the second horizontal plane and perpendicular to the second horizontal plane, and a groove bottom connecting the arc surface and the first side surface.

7. The lens module according to claim 6, wherein the arc surface protrudes outwardly in the direction adjacent to the second barrel wall.
